(19) United States
(12) Patent Application Publication
(10) Pub. No.: US 2014/0265702 A1
(43) Pub. Date: Sep. 18, 2014

(54) Electric Machine with Skewed Permanent Magnet Arrangement

(71) Applicant: Remy Technologies LLC, Pendleton, IN (US)

(72) Inventor: Haodong Li, Seminole, FL (US)

(73) Assignee: Remy Technologies LLC, Pendleton, IN (US)

(21) Appl. No.: 14/213,460

(22) Filed: Mar. 14, 2014

Related U.S. Application Data
(60) Provisional application No. 61/783,592, filed on Mar. 14, 2013.

(51) Int. Cl. H02K 1/27

(52) U.S. Cl. CPC H02K 1/27
USPC 310/156.38

(57) ABSTRACT

A permanent magnet electric machine includes a stator and a rotor opposing the stator. Axial slots are provided in the rotor with a plurality of magnet stacks positioned in the slots. Each of the plurality of magnet stacks includes a plurality of magnet segments. The plurality of magnet segments includes a first number of first magnet segments and a second number of second magnet segments. The first magnet segments are offset from the second magnet segments in a circumferential direction of the rotor. The first number and the second number are both greater than one and the first number is different from the second number.

### CROSS-REFERENCE TO RELATED APPLICATIONS

This application claims priority from U.S. provisional patent application Ser. No. 61/783,592, filed Mar. 14, 2014, the contents of which are incorporated herein by reference in their entirety.

### FIELD

This application relates to the field of electric machines, and particularly electric machines having permanent magnets.

### BACKGROUND

Internal permanent magnet machines have been widely used as driving and generating machines for various applications, including driving machines for hybrid electric vehicles, and generating machines for internal combustion engines. Internal permanent magnet electric machines include a stator separated from a rotor across an air gap. The stator includes a core member with stator slots and a plurality of windings positioned in the stator slots. The rotor includes a rotor core member with a plurality of rotor slots formed in the rotor core member. Permanent magnet (PM) material is positioned in the rotor slots and provides magnetic poles on the rotor. The rotor slots commonly extend in the axial direction for a partial or entire length of the laminated stack.

Various design strategies are common in the design of permanent magnet motors. One common design strategy involves the use of segmented magnets in each rotor slot. Permanent magnet motors have eddy current losses in the magnets due to time-varying magnetic fields passing through the magnets. One method of minimizing these losses in each magnet positioned in a rotor slot is to divide the magnet into multiple segments in the axial, radial or circumferential direction with insulation between each magnet segment. This results in a stack of insulated magnet segments positioned in each slot of the rotor. The insulation between the magnet segments greatly reduces eddy current losses in the magnetized material in each slot. This principle is similar to the minimization of iron losses in the electric machine by using laminated steel structures in the core members of the stator and rotor.

Another design strategy common in the design of permanent magnet motors involves the use of skewed permanent magnet arrangements in the rotor slots. Permanent magnet electric machines experience a fluctuating torque during operation as a result of the position of the poles in the permanent magnet rotor relative to the stator slots. This fluctuation of torque is commonly referred to as “torque ripple”. One strategy for mitigating torque ripple involves stacking the permanent magnets in the lamination stack in an offset manner along the axial direction. As a result, adjacent magnet segments are rotated or offset from each other about the rotor axis, with different magnet segments centered in different axial planes for a given magnetic pole.

In typical skewed permanent magnet arrangements, the magnet segments are offset in equal increments with an equal number of magnets centered in each axial plane for each magnetic pole. For example, with respect to FIGS. 8A and 8B an exemplary prior art skewed PM arrangement is shown with six stacked magnet segments 1-6. Magnet segments 1 and 6 are centered in a first axial plane 7 (axial plane 7 extends out of the page in FIG. 8A, and is perpendicular to the faces 1f, 2f, and 3f of the magnet segments in FIG. 8B). Similarly, magnet segments 2 and 5 are centered in a second axial plane 8, and magnet segments 3 and 4 are centered in a third axial plane 9. The first axial plane 7 is offset from the second axial plane 8 by some distance d, and the second axial plane 8 is also offset from the third axial plane 9 by the same distance d. Thus, as shown in FIG. 8A, two magnet segments are centered in each of planes 7-9. Additionally, the offset between adjacent magnet segments is provided in equal increments, with adjacent magnet segments offset by no more than the offset distance d. These arrangement with equal numbers of magnet segments in each axial plane and an equal incremental offset between adjacent magnet segments have effectively reduced torque ripple in prior art PM electric machines.

While the foregoing skewed permanent magnet arrangements are useful in reducing torque ripple in a permanent magnet electric machine, they also reduce the resulting torque output of the electric machine. In some arrangements, the skewed permanent magnet arrangement may result in an unacceptable reduction in torque. Accordingly, it would be advantageous to provide a permanent magnet electric machine that is capable of significantly reducing torque ripple, but does not reduce the resulting torque output of the electric machine by an unacceptable amount. Furthermore, it would be advantageous if such electric machine could be conveniently and easily manufactured with little additional cost and little or no increase in package size.

While, it would be desirable to provide a permanent magnet electric machine that provides one or more of the above or other advantageous features as may be apparent to those reviewing this disclosure, the teachings disclosed herein extend to those embodiments which fall within the scope of the appended claims, regardless of whether they accomplish one or more of the above-mentioned advantages.

### SUMMARY

In accordance with at least one embodiment of the disclosure, a permanent magnet electric machine comprises a stator and a rotor opposing the stator. A plurality of axial slots is provided in the rotor with a plurality of magnet stacks positioned in the slots. Each of the plurality of magnet stacks include a plurality of magnet segments including a first number of first magnet segments and a second number of second magnet segments. The first magnet segments are offset from the second magnet segments in a circumferential direction of the rotor. The first number and the second number are both greater than one, and the first number is different from the second number.

In accordance with another embodiment of the disclosure an electric machine comprises a stator with a rotor opposing the stator. A plurality of axial slots are provided in the rotor and a plurality of magnet stacks are positioned in the plurality of axial slots. Each of the plurality of magnet stacks includes a plurality of magnet segments of substantially the same size. The plurality of magnet segments in each magnet stack are arranged with a first number of magnet segments centered in a first axial plane, a second number of magnet segments centered in a second axial plane, and a third number of magnet segments centered in a third axial plane, the first number being different from at least one of the second number and the third number.

In accordance with yet another embodiment of the disclosure an electric machine comprises a stator with a rotor opposing the stator. A plurality of axial slots are provided in the rotor and a plurality of magnet stacks are positioned in the axial slots. Each of the plurality of magnet stacks includes a plurality of magnet segments of substantially the same size. The plurality of magnet segments in each magnet stack include first adjacent magnet segments offset by a first offset distance and second adjacent magnet segments offset by a second offset distance, the first offset distance being different from the second offset distance.

The above described features and advantages, as well as others, will become more readily apparent to those of ordinary skill in the art by reference to the following detailed description and accompanying drawings.

### BRIEF DESCRIPTION OF THE DRAWINGS

FIG. 1 shows a partial view of an electric machine including a stator and a rotor core member with internal permanent magnets;

FIG. 2 shows a perspective view of a the rotor core member with internal permanent magnets of FIG. 1;

FIG. 3A shows a plan view of an exemplary permanent magnet stack for insertion into the rotor core member of FIG. 2;

FIG. 3B shows a perspective view of the exemplary permanent magnet stack of FIG. 3A;

FIG. 4A shows a plan view of an alternative embodiment of a permanent magnet stack for insertion into the rotor core member of FIG. 2;

FIG. 4B shows a perspective view of the exemplary permanent magnet stack of FIG. 4A;

FIG. 5A shows a plan view of an alternative embodiment of a permanent magnet stack for insertion into the rotor core member of FIG. 2;

FIG. 5B shows a perspective view of the exemplary permanent magnet stack of FIG. 5A;

FIG. 6 shows a perspective view of an assembled magnet stack of FIG. 3A including filler material;

FIG. 7 shows a block diagram of a method for making an electric machine with one of the exemplary permanent magnet stacks of FIGS. 3A-5B;

FIG. 8A shows a plan view of an exemplary prior art magnet stack for insertion into a rotor core member of an electric machine; and

FIG. 8B shows a perspective view of the exemplary prior art magnet stack of FIG. 8A.

### DESCRIPTION

With reference to FIGS. 1 and 2, a partial view of an electric machine is shown. The electric machine 10 comprises a stator 12 and a rotor 20 opposing the stator 12. A plurality of slots 28 are formed in the rotor 20, each of the plurality of slots is configured to hold a permanent magnet stack 40. It will be appreciated that FIG. 1 shows only about 30° of the rotor and stator arrangement which actually extends 360° to form a complete circular arrangement.

The stator 12 includes a core member 13. The core member 13 may be comprised of a laminated stack of sheets of ferromagnetic material, such as sheets of silicon steel. The core member 13 is generally cylindrical in shape and extends along a rotor axis 11A. The core member 13 includes a substantially circular outer perimeter 14 and a substantially circular inner perimeter 16. The inner perimeter 16 forms a cavity within the stator 12 that is configured to receive the rotor 20. Slots 18 are formed in the core member 13 of the stator 12. These slots 18 are designed and dimensioned to receive conductors 17 that extend in the axial direction through the stator slots 18. In the embodiment of FIG. 1, the slots 18 are partially open slots such that small openings 19 to the slots 18 are provided along the inner perimeter 16 of the stator. The conductors 17 are placed in the winding slots 18 to form windings for the electric machine on the stator.

The rotor 20 includes a core member 22 including a plurality of slots 28 with the magnet stacks 40 positioned in the plurality of slots 28. As shown in FIG. 1, the rotor 20 is designed and dimensioned to fit within in the inner cavity of the stator 12 such that the circular outer perimeter 24 of the rotor 20 is positioned opposite the circular inner perimeter 16 of the stator 12. A small air gap 22 separates the stator 12 from the rotor 20. In at least one alternative embodiment which is generally opposite to that of FIG. 1, the rotor 20 could be positioned outside of the stator 12, as will be recognized by those of ordinary skill in the art.

With particular reference to FIG, 1, the rotor core member 22 is comprised of laminated sheets of ferromagnetic material, such as sheets of steel. The laminated sheets of ferromagnetic material may be formed into “mini-stacks”, with the mini-stacks connected together in order to form the complete rotor core member 22, as described in further detail below. The rotor core member 22 is generally cylindrical in shape and includes a substantially circular outer perimeter 24 and a substantially circular inner perimeter 26. As will be recognized by those of ordinary skill in the art, the inner perimeter 26 of the rotor is coupled to a rotor shaft (not shown) that extends along the rotor axis 11A and delivers a torque output for the electric machine 10.

The slots 28 in the rotor core member 22 extend in the axial direction from a first end 30 to an opposite second end 32 of the rotor core member 22. The slots 28 are generally trapezoidal in cross-sectional shape, with each slot 28 including two elongated sides 34, 36 and two shorter sides 35, 37. The two elongated sides include a stator side 34 and an opposing side 36. The stator side 34 of the slot 28 is positioned closer to the stator 12 than the opposing side 36. Accordingly, the stator side 34 of the slot 30 generally opposes the outer perimeter 24 of the rotor and the opposite side 36 of the slot 30 generally opposes the inner perimeter 26 of the rotor. The shorter sides 35, 37 extend between the ends of the elongated sides 34, 36 in a generally radial direction on the core member 22.

The magnet stacks 40 are fixed in place within the slots 28 of the rotor core member 22. As shown in the embodiment of FIGS. 3A and 3B, each magnet stack 40 includes a plurality of segmented permanent magnets 42 (which may also be referred to herein as “magnet segments”). Each magnet segment 42 is generally that of a rectangular cuboid in shape (which may also be referred to as a rectangular prism). The magnet segments 42 are all generally the same size and shape in the disclosed embodiment of FIGS. 3A and 3B. However, it will be recognized that magnet segments 42 of different sizes and shapes are possible. Each magnet segment 42 in a magnet stack 40 includes at least one adjacent magnet segment, with the magnet segments 42 on the end of a stack 40 including only one adjacent magnet segment, and the remaining magnet segments 42 each having two adjacent magnet segments.

As best shown in FIG. 3B, because of the rectangular cuboid shape of the magnet segments 42 and their designed placement in the rotor 20, each magnet segment 42 may be considered to include opposing axial faces 46, opposing circumferential faces 47 and opposing radial faces 48. Each axial face 46 is provided on a surface of the magnet segment 42 that is substantially perpendicular to the rotor axis 11A when the associated magnet stack 40 is placed in the rotor core member 22. Each circumferential face 47 is provided on a surface of the magnet segment 42 that is substantially parallel to the rotor axis 11A and the radial direction 11B, and is substantially perpendicular to the circumferential direction 11C of the rotor 20 (as defined at a tangent of the rotor, as shown in FIG. 1). Each radial face 48 is provided on a surface of the magnet segment 42 that is substantially parallel to the rotor axis 11A and is substantially perpendicular to the radial direction 11B.

The magnet segments 42 in the magnet stack 40 are each in contact with at least one adjacent magnet segment in the same magnet stack 40. This contact may be a direct contact or an indirect contact via insulation layers provided between adjacent magnet segments. Contact between adjacent magnet segments 42 occurs along the axial faces 46. In the embodiments of FIGS. 3A and 3B, at least a majority of each axial face 46 overlaps the adjacent axial face of the adjacent magnet segment in the axial direction. In this embodiment, some of the adjacent axial faces are completely aligned and completely overlap, such as the adjacent axial faces 42a₁ and 42a₂ in FIG. 3A. Other of the adjacent axial faces are offset from each other by some relatively small offset distance such that a majority portion of the adjacent axial faces still overlap, such as the adjacent axial faces 42a₃ and 42b₁ in FIG. 3A.

As mentioned above, the magnet segments 42 in each magnet stack 40 are provided in a skewed arrangement such that some of the magnet segments 42 are offset from other magnet segments 42 in the circumferential direction 11C within the magnet stack 40. As a result, different magnet segments 42 in a magnet stack 40 will be positioned in different axial planes (i.e., planes that are parallel to the rotor axis 11A). In the exemplary embodiment of FIG. 3A, a magnet stack 40 includes leading magnet segments 42a in axial plane 41a, intermediate magnet segments 42a in axial plane 41b, and trailing magnet segments 42c in axial plane 41c. Each of axial planes 41a, 41b and 41c is a plane extending parallel to the rotor axis 11A and cuts through center of the associated magnet segments 42a, 42b and 42c.

As shown in FIGS. 3A and 3B, the magnet stack 40 includes three leading magnet segments 42a₁, 42a₂, and 42a₃ that form a leading magnet sub-stack 40a, six intermediate magnet segments 42b₁-42b₆ that form an intermediate magnet sub-stack 40b, and three trailing magnet segments 42c₁-42c₃ that form a trailing magnet sub-stack 40c. The magnet segments 42a₁-42a₃ in the leading magnet substack 40a are offset from the magnet segments 42b₁-42b₆ in the intermediate magnet substack 40b by an offset distance d in a circumferential direction of the rotor. Similarly, the magnet segments 42b₁-42b₆ in the intermediate magnet substack 40b are offset from the magnet segments 42c₁-42c₃ in the trailing magnet substack 40c by the same offset distance d. As a result, the magnet segments 42a₁-42a₃ in the leading magnet substack 40a are offset from the magnet segments 42c₁-42c₃ in the trailing magnet substack 40c by an offset distance of 2d.

The offset distance d may be defined in different ways. For example, the offset distance d may be a distance in centimeters. Alternatively, the offset distance d may be defined by a number of mechanical degrees (θ) based on rotation of the rotor 20. In at least one embodiment the offset distance d is based on an angle θ between two and five mechanical degrees, and particularly, about three mechanical degrees. Knowing this angle θ, the distance d between axial planes 41a and 41b may be calculated by multiplying sin 0 by the distance between the rotor axis and the offset location.

Groups of the magnet segments 42 in a given substack 40a, 40b, and 40c are cohered together to form a unitary component. For example, in FIG. 3A, all the magnet segments 42a₁-42a₃ are cohered together, all the magnet segments 42b₁-42b₆ are cohered together, and all the magnet segments 42c₁-42c₃ are cohered together. The completed magnet sub-stacks 40a-40c in the embodiments of FIGS. 1-3B are generally rectangular cuboid in shape. Before or after the magnet substacks 40a-40c are inserted into a mini-stack of rotor laminations, the individual magnet substacks 40a-40c are overmolded with a filler material 50 such as an epoxy, nylon or other potting material or filler material about the perimeter portions of the magnet segments 42 such that filler material is provided in the empty slot portions 38.

FIG. 6 shows the exemplary magnet stack 40 of FIG. 3B formed as a complex prism including multiple substacks 40a-40c each overmolded with a filler material 50 to form a generally rectangular cuboid shape. The combination of substacks 40a-40c are connected together to form the complete magnet stack 40. However, it will be recognized that in other embodiments, the magnet stack 40 may be provided in other forms or shapes than that of a complex prism. For example, the magnet stack 40 may include additional potting material such that the overall shape of the magnet stack 40 is simply that of a rectangular cuboid in shape.

With reference again to FIG. 1, the complete magnet stacks 40 are positioned in the slots 28 of the rotor 20. Each magnet stack 40 fills a substantial portion of the associated slot 28, with empty slot portions 38 provided along the side of the slot 28. These empty slot portions 38 may remain as voids in the slots 28 or be filled by non-ferromagnetic materials, such as nylon or other filler material. The magnet stacks 40 have a direction of magnetization in the radial direction. Accordingly, one magnet pole faces the stator side 34 of the slot 28 and an opposite magnet pole faces the inner side 36 of the slot. As shown by the “N” and “S” markings in FIG. 2, the pole facing the stator alternates between magnet stacks when moving around the rotor. The offset between the magnet segments in the magnet stack 40 is illustrated by dotted lines 54.

FIGS. 4A and 4B show an alternative embodiment of the magnet stack 40 to that shown in FIGS. 3A and 3B, with the same reference numerals representing the same components, but in a slightly different configuration. While the embodiment of FIGS. 3A and 3B shows the leading, intermediate and trailing magnet substacks 40a, 40b and 40c centered in three axial planes in a 3:6:3 arrangement, the embodiment of the magnet stack 40 of FIGS. 4A and 4B shows the leading, intermediate and trailing magnet segments 42a₁-42a₂, 42b₁-42b₆, and 42c₁-42c₄ centered in three axial planes in a 2:6:4 arrangement (with a 1:2:6:2:1 leading:trailing:intermediate:trailing:leading magnet segment configuration). Additionally, the leading magnet substacks 40a are adjacent to the trailing magnet substacks 40c and offset by an offset distance of 2d, while the intermediate magnet substack 40b is adjacent to the trailing magnet substacks 40c but only offset by an offset distance of d.

FIGS. 5A and 5B show yet another alternative embodiment of the magnet stack 40 to that shown in FIGS. 3A and 3B, with the same reference numerals representing the same components, but in a slightly different configuration. The embodiment of the magnet stack 40 of FIGS. 5A and 5B shows the leading, intermediate and trailing magnet substacks 40a, 40b and 40c centered in three different axial planes in a 4:4:4 arrangement (with a 2:2:4:2:2 leading:trailing:intermediate:trailing:leading magnet segment configuration). Additionally, similar to the embodiment of FIGS. 4A and 4B, the leading magnet substacks 40a are adjacent to the trailing magnet substacks 40c and offset by an offset distance of 2d, while the intermediate magnet substack 40b is adjacent to the trailing magnet substacks 40c but only offset by an offset distance of d.

With reference now to FIG. 7, a method of manufacturing a rotor for an electric machine is described. The method begins with the formation of individual magnet segments 42, as shown in block 70. The gross shape of each magnet segment is determined during the formation process. Magnet segments 42 may be formed by any of various processes as will be recognized by those of skill in the art. For example, the magnet segments 42 may be formed by making a long magnet and then cutting the long magnet into shorter magnet segments, which are coarse-toleranced dimensionally. As another example, magnet segments may be formed by pressing magnetic material into a die or molding magnetic material to form a magnet segment. Formed magnet segments may or may not be sintered afterwards.

Next, as shown in block 72, the formed magnet segments are assembled into magnet substacks (e.g., 40a, 40b or 40c) with a number of aligned magnet segments.

After the magnet segments are assembled in a magnet substacks (or in conjunction with this step), the magnet substacks may be subjected to a cohering process, as shown in block 74 of FIG. 7. The cohering process is designed to cause the coarse magnet segments 42 of each magnet substack to become a coherent component that is unitary such that all magnet segments remain together on the substack. One exemplary cohering process may include overmolding the coarse magnet segments with an epoxy or other potting material. Another exemplary cohering process may include hot-melting adhesive layers between the magnet segments to form the magnet stack as a unitary component. In this embodiment, the cohering process of step 74 is performed in association with step 72 during assembly of the magnet substack. In yet another embodiment, the cohering process may include sintering the completely assembled magnet substack. Although a cohering process has been disclosed herein with the embodiment of FIG. 7, it will be appreciated that other embodiments may not include this cohering step. For example, in at least one embodiment, the magnets segments 42 that form the magnet substack are not cohered or otherwise bonded together before finishing.

As shown in block 76, after a magnet substack is assembled and cohered, the magnet substack is finished by grinding the axial ends of the magnet substack 40a, 40c or 40c. Following finish grinding of the magnet substack, the magnet substack is inserted into a mini-stack of laminations for a core member of an electric machine, as shown in block 78. For example, the magnet stack may be inserted into a slot provided by the mini-stacks of a rotor 20 of an electric machine, as shown in FIG. 1. Once inserted into the slot, the first end and the second end of the magnet stack 40 are substantially flush with the associated first end and second end faces of the mini-stack rotor laminations. In at least one alternative embodiment, the magnet substack is overmolded with a filler material 50 after it is positioned in the slots of a mini-stack. In this embodiment, the axial ends of the magnet substack may be finish ground with the magnet substack positioned within the slots of the mini-stack.

With continued reference to FIG. 7, once the mini-stacks of core laminations are assembled in block 78, including the magnet substacks within the slots of the ministacks, the ministacks are then assembled into a complete core member for the electric machine, as shown in block 80. The mini-stacks are cohered together to form the complete core member using any of various known techniques to those of ordinary skill in the art, such as welding or the use of adhesives. When the mini-stacks cohered together as a complete electric machine core, the magnet stacks 40 are completed as magnet substacks associated with each mini-stack are positioned adjacent to other magnet substacks associated with other ministacks. Examples of completed magnet stacks 40 are shown above in FIGS. 3A-5B. As noted above, a number of adjacent magnet segments 42 are offset within each magnet stack 40. In particular, the magnet segments 42 are arranged such that each of the plurality of magnet stacks 40 includes a first number of leading magnet segments 42a, a second number of trailing magnet segments 42c, and a third number of intermediate magnet segments 42b, such as those shown in FIGS. 3A and 4A. The leading magnet segments 42a are offset from the intermediate magnet segments 42c and the trailing magnet segments 42b by an offset distance in a circumferential direction of the rotor. Similarly, the trailing magnet segments 42b are also offset from the intermediate magnet segments 42c and the leading magnet segments 42a by an offset distance in a circumferential direction 11C of the rotor 20. In at least some embodiments, the offset distance between some adjacent magnet segments (e.g., magnet segments 42a₁ and 42c₁ in FIG. 4A) is greater than the offset distance between other adjacent magnet segments 42b (e.g., 42b₁ and 42c₂ in FIG. 4A).

Again, some of the differences between the embodiments of the magnet stacks 40 disclosed herein and prior art magnet stacks are illustrated in FIGS. 3A through 5B. These differences may include (i) unequal numbers of magnet segments centered in each axial plane, and/or (ii) differing offsets between adjacent magnet segments, as well as other differences as described above. In contrast to prior art methods, the magnet stacks for use in a permanent magnet electric machine as described herein significantly reduces torque ripple without an unacceptable reduction in torque output of the electric machine. As a result, the method for manufacturing an electric machine with interior permanent magnets as described herein offers significant advantages over the prior art.

Although the electric machine with segmented permanent magnets and method of making the same has been described with respect to certain preferred embodiments, it will be appreciated by those of skill in the art that other implementations and adaptations are possible. Moreover, there are advantages to individual advancements described herein that may be obtained without incorporating other aspects described above. Therefore, the spirit and scope of the appended claims should not be limited to the description of the preferred embodiments contained herein.

What is claimed is:

1. An electric machine comprising:
a stator;
a rotor opposing the stator;
a plurality of axial slots provided in the rotor; and
a plurality of magnet stacks positioned in the plurality of axial slots in the rotor, each of the plurality of magnet stacks including a plurality of magnet segments including a first number of first magnet segments and a second number of second magnet segments, the first magnet segments offset from the second magnet segments in a circumferential direction of the rotor by an offset distance, the first number and the second number both greater than one and the first number different from the second number.

2. The electric machine of claim 1 wherein the plurality of magnet segments are substantially the same size, and wherein each of the plurality of magnet segments contacts at least one adjacent magnet segment in one of the magnet stacks.

3. The electric machine of claim 2 wherein the plurality of magnet stacks and the plurality of magnet segments are a complex prism in shape, and wherein the plurality of magnet stacks includes potting material provided along the perimeter portions of the magnet stacks.

4. The electric machine of claim 2 wherein the first magnet segments are offset from the second magnet segments by about three degrees in the circumferential direction of the rotor.

5. The electric machine of claim 1 wherein each of the plurality of magnet segments includes a first axial face overlapping a second axial face of at least one adjacent magnet segment.

6. The electric machine of claim 5 wherein a majority of the first axial face overlaps at least a majority of the second axial face.

7. The electric machine of claim 6 wherein the first axial face is in direct contact with the second axial face.

8. The electric machine of claim 1 wherein the first magnet segments are leading magnet segments and the second magnet segments are trailing magnet segments and the offset distance is a first offset distance, the plurality of magnet segments further including a third number of intermediate magnet segments offset from the leading magnet segments and the trailing magnet segments by a second offset distance, the second offset distance being half the first offset distance.

9. The electric machine of claim 8 wherein the first number is two, the second number is four and the third number is six.

10. The electric machine of claim 8 wherein the first number is four, the second number is two, and the third number is two.

11. An electric machine comprising:
a stator;
a rotor opposing the stator;
a plurality of axial slots provided in the rotor; and
a plurality of magnet stacks positioned in the plurality of axial slots in the rotor, each of the plurality of magnet stacks including a plurality of magnet segments of substantially the same size, the plurality of magnet segments in each magnet stack consisting of a first number of adjacent magnet segments centered in a first axial plane, a second number of adjacent magnet segments centered in a second axial plane, and a third number of adjacent magnet segments centered in a third axial plane.

12. The electric machine of claim 11 wherein the first number is different from at least one of the second number and the third number.

13. The electric machine of claim 11 wherein the first axial plane is offset from the second axial plane by about three degrees in the circumferential direction of the rotor, and wherein the second axial plane is offset from the third axial plane by about three degrees in the circumferential direction of the rotor.

14. The electric machine of claim 11 wherein each of the plurality of magnet segments in each magnet stack includes a first axial face overlapping a second axial face on at least one adjacent magnet segment.

15. The electric machine of claim 14 wherein at least a majority of the first axial face overlaps a majority of the second axial face.

16. The electric machine of claim 11 wherein the first number is two, the second number is six and the third number is four.

17. The electric machine of claim 11 wherein the first number is three, the second number is six and the third number is three.

18. The electric machine of claim 11 wherein the first number is four, the second number is two and the third number is two.

19. An electric machine comprising:
a stator;
a rotor opposing the stator;
a plurality of axial slots provided in the rotor; and
a plurality of magnet stacks positioned in the plurality of axial slots in the rotor, each of the plurality of magnet stacks including a first magnet substack adjacent to a second magnet substack, and a third magnet substack adjacent to the second magnet substack, the first magnet substack offset by a first offset distance from the second magnet substack and the second magnet substack offset by a second offset distance from the third magnet substack, wherein the first offset distance is less than the second offset distance, wherein the number of magnets in each of the first magnet substack, the second magnet substack, and third magnet substack is greater than or equal to one.

20. The electric machine of claim 19 wherein the first magnet substack includes a first number of trailing magnet segments, the second magnet substack includes a second number of intermediate magnet segments, and the third magnet substack a third number of leading magnet segments, wherein the leading magnet segments are offset from the trailing magnet segments by the second offset distance, and wherein the intermediate magnet segments are offset from the leading magnet segments and the trailing magnet segments by the first offset distance.
